(19) United States
(12) Patent Application Publication
(10) Pub. No.: US 2018/0015379 A1
(43) Pub. Date: Jan. 18, 2018

(54) METHOD OF CREATING A DOLL MODELED AFTER A BABY

(71) Applicant: Nevin Pratt, West Valley City, UT (US)

(72) Inventor: Nevin Pratt, West Valley City, UT (US)

(21) Appl. No.: 15/210,804

(22) Filed: Jul. 14, 2016

(51) Int. Cl. A63H 9/00; B29L 31/52; B29K 91/00

(52) U.S. Cl. CPC A63H 9/00; B33Y 50/00; B33Y 10/00; B29K 2091/00; B29L 2031/5218; B33Y 80/00

(57) ABSTRACT

A method of creating a doll modeled after a baby. The method includes performing a 3D scan of a body part of a baby and converting the 3D scan to a 3D model. The method also includes printing a physical model of the body part with a 3D printer based on the 3D model

### CROSS-REFERENCE TO RELATED APPLICATIONS

Not applicable.

### BACKGROUND OF THE INVENTION

Currently, to create a doll part modeled after a baby the entire process is carried out by hand. Specifically, a wax model is created by hand either by looking at the baby or by referencing photographs of the baby. For example, if a model of the baby's head is being created then an artist carves a model of the baby's head in wax. This is, obviously, a very time intensive process and leads to numerous problems.

The first problem is that very few people have the necessary skills to create the wax model. This means that both there may be significant delays before the model can be created and that the creation of the wax model can be expensive. Further, the speed at which the wax model can be created depends entirely on the sculptor and cannot be controlled by the producer of the doll.

Second, only a single wax model is typically created. Therefore, if any damage occurs then for all intents and purposes the entire creation of the wax model was wasted unless a mold has been previously created. Since the wax model is shipped to a manufacturer (which may be overseas) any shipping damage means that the process may be started again from the beginning.

Accordingly, there is a need in the art that can allow for automatic creation of the wax model. Moreover, there is a need in the art for the process to be able to create multiple wax model to avoid problems associated with shipping damage.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of creating a doll modeled after a baby. The method includes performing a 3D scan of a body part of a baby and converting the 3D scan to a 3D model. The method also includes printing a physical model of the body part with a 3D printer based on the 3D model.

Another example embodiment includes a method of creating a doll modeled after a baby. The method includes performing a first 3D scan of a body part of a baby at a first scan angle and converting the first 3D scan to a first 3D model. The method also includes performing a second 3D scan of the body part of a baby at a second scan angle, wherein the second scan differs from the first scan angle and converting the second 3D scan to a second 3D model. The method further includes aligning the first 3D model and the second 3D model to create a single 3D model and enhancing the single 3D model to create an enhanced model. The method additionally includes printing a physical model with a 3D printer based on the enhanced model.

Another example embodiment includes a method of creating a doll modeled after a baby. The method includes performing a first 3D scan of a body part of a baby at a first scan angle and converting the first 3D scan to a first 3D model. The method also includes performing a second 3D of the body part of a baby at a second scan angle, wherein the second scan differs from the first scan angle and converting the second 3D scan to a second 3D model. The method further includes aligning the first 3D model and the second 3D model to create a single 3D model and enhancing the single 3D model to create an enhanced model. The method additionally includes printing a physical model with a 3D printer based on the enhanced model. The method moreover includes casting a mold from the physical model and casting a doll part from the mold.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of creating a doll modeled after a baby;

FIG. 2 illustrates an example of 3D models which have been created as a result of a scan of a baby's head;

FIG. 3 illustrates an example of a model that combines the models of FIG. 2; and

FIG. 4 illustrates an example of a final enhanced model; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

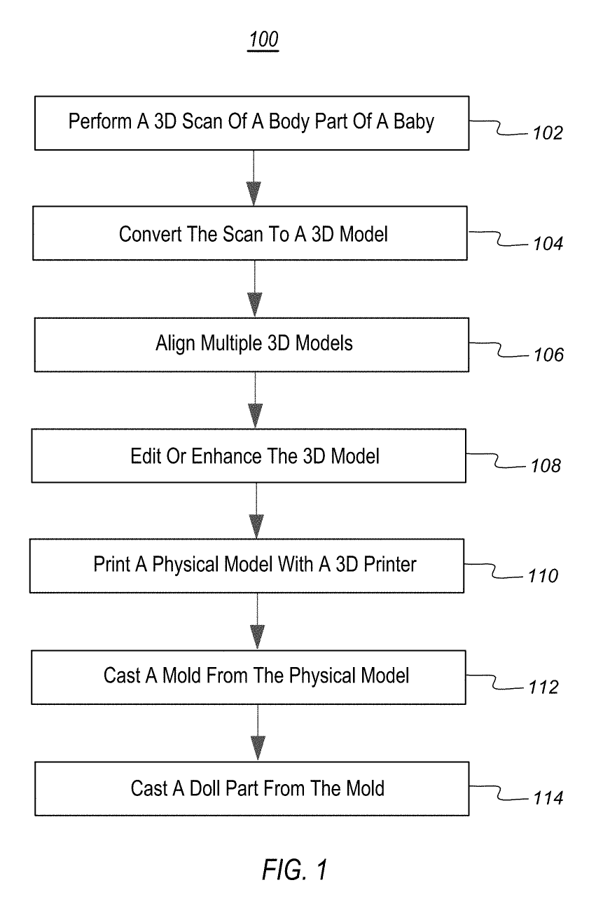

FIG. 1 is a flowchart illustrating a method 100 of creating a doll modeled after a baby. The doll is more lifelike than other dolls because it copies the details of an actual baby. As used herein, “baby” also includes infants or toddlers. Any desired portion of the baby can be modeled. For example, the head of the baby may be modeled and attached to a doll that is not modeled after the baby or the head, hands and feet may be based on the baby with other parts created from a general model.

FIG. 1 shows that the method 100 can include performing 102 a 3D scan of a body part of a baby. A 3D scanner is a device that analyses the surface of a real-world object or environment to collect data on its shape and possibly its appearance (e.g. color). The selection of an appropriate 3D scanner used is always a tradeoff. In particular, the faster the scan is complete, the lower the resolution becomes. Therefore, a 3D scan cannot be performed 102 that is both high resolution and fast. With a stationary object, this is not a problem but with a baby it becomes problematic because the baby doesn't hold still even when calm or sleeping since biological functions such as breathing and heart beat cause slight movements. Therefore, a balance must be achieved between resolution and speed.

Further, many different technologies can be used to build these 3D-scanning devices; each technology comes with its own limitations, advantages and costs. Many limitations in the kind of objects that can be digitized are still present, for example, optical technologies encounter many difficulties with shiny, mirroring or transparent objects. Examples of 3D scanners that produce acceptable scan times with sufficiently high resolutions are LMI3D's HDI Advanced R3X scanners and LMI3D's HDI 100 series 120 model.

If color information is collected at each point, then the colors on the surface of the subject can also be determined. 3D scanners share several traits with cameras. Like most cameras, they have a cone-like field of view, and like cameras, they can only collect information about surfaces that are not obscured. While a camera collects color information about surfaces within its field of view, a 3D scanner collects distance information about surfaces within its field of view. The “picture” produced by a 3D scanner describes the distance to a surface at each point in the picture. This allows the three dimensional position of each point in the picture to be identified.

FIG. 1 moreover shows that the method 100 can include converting 104 the scan to a 3D model. I.e., the data collected in the 3D scan can then be used to construct digital three-dimensional models (a process called reconstruction). One of skill in the art will appreciate that the conversion 104 may, and often does, occur as part of the scan. I.e., the output of the 3D scan may be a model that can be used as described below. The point clouds produced by 3D scanners and 3D imaging can be used directly for measurement and visualization; most applications, however, use instead polygonal 3D models, NURBS surface models, editable feature-based CAD models (aka Solid models) or similar modeling programs.

Polygon mesh models: In a polygonal representation of a shape, a curved surface is modeled as many small faceted flat surfaces (e.g., a sphere modeled as a disco ball). Polygon models—also called Mesh models, are useful for visualization, for some CAM (i.e., machining), but are generally “heavy” (i.e., very large data sets), and are relatively un-editable in this form. Reconstruction to polygonal model involves finding and connecting adjacent points with straight lines in order to create a continuous surface. Many applications, both free and for a cost, are available for this purpose (e.g. MeshLab, PointCab, kubit PointCloud for AutoCAD, JRC 3D Reconstructor, imagemodel, PolyWorks, Rapidform, Geomagic, Imageware, Rhino 3D etc.).

Surface models: The next level of sophistication in modeling involves using a quilt of curved surface patches to model our shape. These might be NURBS, TSplines or other curved representations of curved topology. Using NURBS, our sphere is a true mathematical sphere. Some applications offer patch layout by hand but the best in class offer both automated patch layout and manual layout. These patches have the advantage of being lighter and more manipulatable when exported to CAD. Surface models are somewhat editable, but only in a sculptural sense of pushing and pulling to deform the surface. This representation lends itself well to modelling organic and artistic shapes. Providers of surface modelers include Rapidform, Geomagic, Rhino 3D, Maya, T Splines etc.

Solid CAD models: From an engineering/manufacturing perspective, the ultimate representation of a digitized shape is the editable, parametric CAD model; since CAD is the common “language” of industry to describe, edit and maintain the shape of the enterprise's assets. In CAD, our sphere is described by parametric features which are easily edited by changing a value (e.g., center point and radius).

These CAD models describe not simply the envelope or shape of the object, but CAD models also embody the “design intent” (i.e., critical features and their relationship to other features). An example of design intent not evident in the shape alone might be a brake drum's lug bolts, which must be concentric with the hole in the center of the drum. This knowledge would drive the sequence and method of creating the CAD model; a designer with an awareness of this relationship would not design the lug bolts referenced to the outside diameter, but instead, to the center. A modeler creating a CAD model will want to include both Shape and design intent in the complete CAD model.

Vendors offer different approaches to getting to the parametric CAD model. Some export the NURBS surfaces and leave it to the CAD designer to complete the model in CAD (e.g., Geomagic, Imageware, Rhino 3D). Others use the scan data to create an editable and verifiable feature based model that is imported into CAD with full feature tree intact, yielding a complete, native CAD model, capturing both shape and design intent (e.g. Geomagic, Rapidform). Still other CAD applications are robust enough to manipulate limited points or polygon models within the CAD environment (e.g., CATIA, AutoCAD, Revit).

FIG. 1 also shows that the method 100 can include aligning 106 multiple 3D models. Because the field of view of the scanners might not capture the entire part of the model (head, arms, legs, etc.) then it is necessary to capture the different angles of the model (top, bottom, left side, right side, etc.) and align them together. So, for example, a scan of the top of the head may be aligned with a scan of the front of the head to create a more complete model. One of skill in the art will appreciate that the alignment can be done automatically during the scan. I.e., during the performance of the 3D scan or the conversion 104 of the scan to a 3D model multiple 3D models can automatically be aligned 106 creating a single 3D model.

FIG. 1 further shows that the method 100 can include editing 108 or enhancing the 3D model. Enhancement can include any desired changes or edits to the model to improve the final product. Details such as wrinkles and creases are enhanced to enable them to show up in the final product. Fixes and/or changes may also be applied. E.g., opening or closing eyes, opening or closing a mouth, changing (bending/unbending) angles of joints such as elbows, knees, fingers, etc., removing hair from the body part, positioning of limbs or features are adjusted as desired. Examples of software that can be used to edit the 108 the 3D model are Zbrush and Mudbox.

FIG. 1 additionally shows that the method 100 can include printing 110 a physical model with a 3D printer. 3D printers don't print vinyl well and they do the printing very slowly compared to injection molding. Likewise, using a baby to create a mold is impossible. Therefore, a physical model allows for use in a molding process providing speed and accuracy. To allow for the molding process a physical model is needed, ideally of wax. Therefore, either the print is done in wax or, because 3D printing of wax is often unreliable, a physical model is printed in a material, such as plastic, ceramic, which is then, in turn, used to create a wax model. One of skill in the art will appreciate that multiple physical models may be created. For example, a physical model of the baby's head, arms and legs may all be created or each physical model may be created multiple times for redundancy. Examples of 3D printers that can be used to print 110 the physical model are 3D Systems ProJet HD 3500Max, 3D Systems ProJet 3510 SD, 3D Systems ProJet MJP 3600W Series, Objet's Eden 350V model, Objet's Eden 500V model, Stratasys's Connex 3 model and other similar 3D printers.

3D printing, also known as additive manufacturing (AM), refers to various processes used to synthesize a three-dimensional object. In 3D printing, successive layers of material are formed under computer control to create an object. These objects can be of almost any shape or geometry and are produced from a 3D model or other electronic data source. 3D printing in the term's original sense refers to processes that sequentially deposit material onto a powder bed with inkjet printer heads. More recently, the meaning of the term has expanded to encompass a wider variety of techniques such as extrusion and sintering-based processes

Once completed, the print file (known as an STL file) needs to be processed by a piece of software called a “slicer,” which converts the model into a series of thin layers and produces a G-code file containing instructions tailored to a specific type of 3D printer. This G-code file can then be printed with 3D printing client software (which loads the G-code, and uses it to instruct the 3D printer during the 3D printing process). Printer resolution describes layer thickness and X-Y resolution in dots per inch (dpi) or micrometers (μm). Typical layer thickness is around 100 μm (250 DPI), although some machines can print layers as thin as 16 μm (1,600 DPI). The particles (3D dots) are around 50 to 100 μm (510 to 250 DPI) in diameter.

FIG. 1 moreover shows that the method 100 can include casting 112 a mold from the physical model. The mold is used to mass produce the vinyl parts that will be used to create the doll. For example, the mold can be cast 112 using the “lost wax casting” or “investment casting” technique. A wax model is dipped in a chemical bath and through chemical electrolysis a negative metal mold is created. The wax is then melted out and just the negative metal mold is left over.

FIG. 1 also shows that the method 100 can include casting 114 a doll part from the mold. A liquid vinyl mixture is poured into the mold. It is then attached to a rotational oven where it rotates slowly on all axes. This causes the liquid vinyl to evenly coat inside the mold. The vinyl is then cooled and the final product is pulled out of the casting mold.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

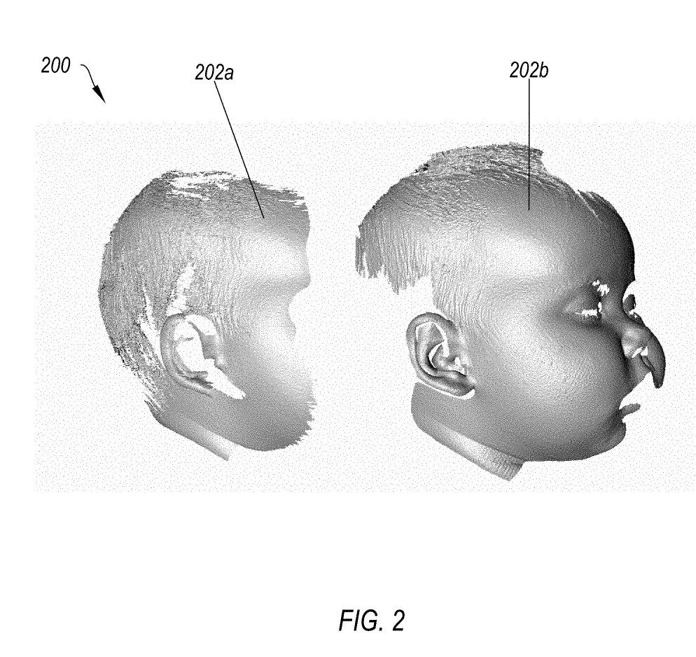

FIG. 2 illustrates an example of 3D models 200 which have been created as a result of a scan of a baby's head. The models 200 are of different portions of the baby's head. In particular, the left model 202a is a model that resulted from a scan that covered the right side of the baby's head and the right model 202b is a model that resulted from a scan that covered the top and front of the baby's head. One of skill in the art will appreciate that there is overlap in the areas that were modeled (e.g., the right ear of the baby).

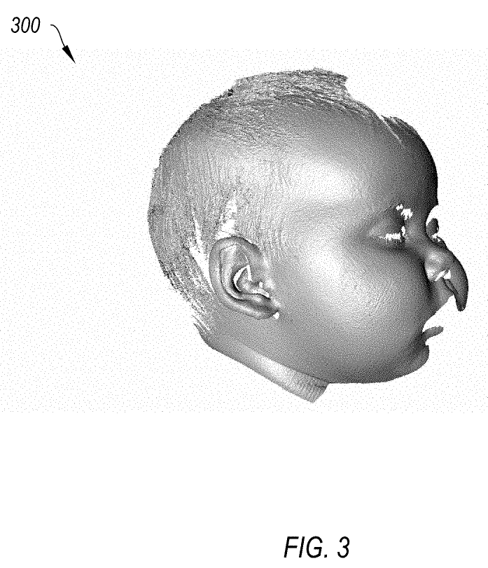

FIG. 3 illustrates an example of a model 300 that combines the models 202a and 202b of FIG. 2. In particular, the models have been aligned with one another to produce a single model 300 (in this case a mesh model) that includes the data of both models. One of skill in the art will appreciate that some details may vary in the separate models 202a and 202b that need to be corrected in the model 300. That is, slight movements between scans may mean that not all data points align exactly.

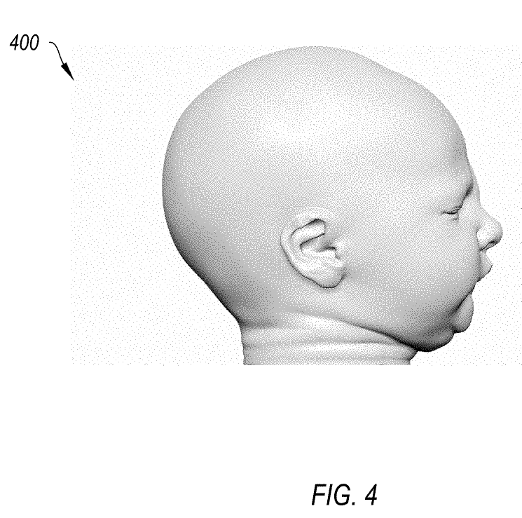

FIG. 4 illustrates an example of a final enhanced model 400. The model 400 has had imperfections from the scan removed and wrinkles emphasized to create a better finished product (i.e., closer to the original baby). Enhancements may be done to improve the final cast. I.e., since a cast must be made to produce the vinyl doll parts the enhancements can allow for a better final product such as removal of hair from the final model. Additionally or alternatively, the enhanced model may have flaws introduced during the scan removed.

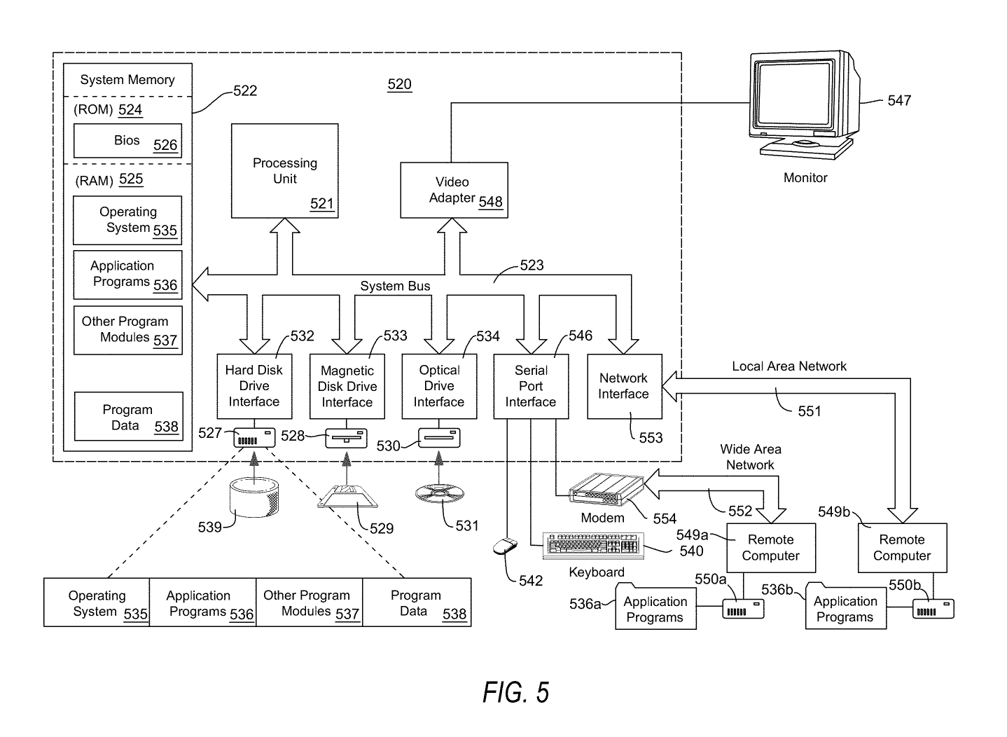

FIG. 5, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, motion detectors or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of creating a doll modeled after a baby, the method comprising:
performing a 3D scan of a body part of a baby;
converting the 3D scan to a 3D model; and
printing a physical model of the body part with a 3D printer based on the 3D model.

2. The method of claim 1 further comprising combining a first 3D model from a first 3D scan with a second 3D model from a second 3D scan to create the 3D model.

3. The method of claim 1 wherein combining the first 3D model from the first 3D scan with the second 3D model from the second 3D scan to create the 3D model includes aligning the first 3D model and the second 3D model.

4. The method of claim 1, wherein the physical model is printed in wax.

5. The method of claim 1, wherein the body part of the baby includes the head of the baby.

6. The method of claim 1, wherein the body part of the baby includes an arm of the baby.

7. The method of claim 1, wherein the body part of the baby includes a leg of the baby.

8. The method of claim 1, wherein the body part of the baby includes the torso of the baby.

9. A method of creating a doll modeled after a baby, the method comprising:
performing a first 3D scan of a body part of a baby at a first scan angle;
converting the first 3D scan to a first 3D model;
performing a second 3D of the body part of a baby at a second scan angle, wherein the second scan differs from the first scan angle;
converting the second 3D scan to a second 3D model;
aligning the first 3D model and the second 3D model to create a single 3D model;
enhancing the single 3D model to create an enhanced model; and
printing a physical model with a 3D printer based on the enhanced model.

10. The method of claim 9, wherein enhancing the 3D model includes deepening wrinkles.

11. The method of claim 9, wherein enhancing the 3D model includes at least one of:
opening eyes; or
closing eyes.

12. The method of claim 9, wherein enhancing the 3D model includes at least one of:
bending a joint; or
unbending a joint.

13. The method of claim 9, wherein enhancing the 3D model includes at least one of
opening a mouth; or
closing a mouth.

14. The method of claim 9, wherein enhancing the 3D model includes removing hair from the body part.

15. A method of creating a doll modeled after a baby, the method comprising:
performing a first 3D scan of a body part of a baby at a first scan angle;
converting the first 3D scan to a first 3D model;
performing a second 3D of the body part of a baby at a second scan angle, wherein the second scan differs from the first scan angle;
converting the second 3D scan to a second 3D model;
aligning the first 3D model and the second 3D model to create a single 3D model;
enhancing the single 3D model to create an enhanced model; and
printing a physical model with a 3D printer based on the enhanced model;
casting a mold from the physical model; and
casting a doll part from the mold.

16. The method of claim 15, wherein the physical model is dipped in a chemical bath and through chemical electrolysis a negative metal mold is created.

17. The method of claim 15, wherein casting a doll part from the mold includes pouring a liquid vinyl mixture into the mold.

18. The method of claim 17, wherein casting a doll part from the mold further includes attaching the mold to a rotational mold.

19. The method of claim 18, wherein casting a doll part from the mold further includes cooling the liquid vinyl mixture to for a solid vinyl doll part.

20. The method of claim 19, wherein casting a doll part from the mold further includes removing solid vinyl doll part from the mold.
